(19) United States
(12) Patent Application Publication
(10) Pub. No.: US 2011/0313759 A1
(43) Pub. Date: Dec. 22, 2011

(54) Method for changing the caller voice during conversation in voice communication device

(76) Inventor: Alon Konchitsky, Santa Clara, CA (US)

(21) Appl. No.: 13/162,003

(22) Filed: Jun. 16, 2011

Related U.S. Application Data
(60) Provisional application No. 61/356,264, filed on Jun. 18, 2010.

(51) Int. Cl. G10L 21/00

(52) U.S. Cl. 704/207; 704/E21.001

(57) ABSTRACT

The invention relates to a cellular phone terminal system and in particular to a method for changing caller's voice of speech signal during conversation. The cellular phone terminal system has a filter for filtering signal. The method comprises the steps of: waiting for a caller voice selector key input for a desired caller voice when a caller voice converter key is pressed during conversation; and setting an even or odd harmonic deletion bins on the frequency domain of the uncompressed speech signal correspondingly to the caller voice selector key input to change caller voice.

### CROSS-REFERENCE TO A RELATED APPLICATION

This application claims the benefit and priority date of provisional patent application 61/356,264 filed on Jun. 18, 2010, the contents of which are incorporated herein by reference.

### BACKGROUND OF THE INVENTION

1. Field of the Invention

The invention relates to a voice communication device like a cellular telephone or voice over internet protocol (VOIP) terminal, and in particular to a method for changing caller's voice of speech signal during conversation in the communication device.

2. Description of the Related Art

In general, a voice coder of a cellular phone terminal has a filter, for example an FIR (Finite Impulse Response) or other filters, to improve caller's voice which are transmitted and received during a conversation. In other words, filter coefficients of the FIR filter are suitably changed and the transmitted/received voices are accordingly equalized to improve the caller's voice.

However, the filters provided in conventional voice communication device have been typically used only for improving the caller's voice during conversation, but not for changing the voice from a male voice to a woman or a child. Other cases could be making funny voices like animal voices, without destroying intelligibility of the voice source.

### SUMMARY OF THE INVENTION

It is therefore an object of the invention to provide a method for changing caller's voice during conversation in a voice communication device.

To achieve the objective of the invention, a method is provided for changing caller's voice on a voice communication device having a filter for filtering. The said method comprises the steps of: waiting for a caller voice selector key input for a desired caller voice when a caller voice converter key is pressed during conversation; and setting a filter coefficient of the filter correspondingly to the caller voice selector key input and filtering the uncompressed speech signal to change caller's voice.

### BRIEF DESCRIPTION OF THE DRAWINGS

FIG. 1 is a block diagram showing the internal structure of a voice communication device, including but not limiting to a cellular phone, Voice Over Internet Protocol (VOW) or a Personal Digital Assistant (PDA), for performing functions according to a preferred embodiment of the invention;

FIG. 2 is a block diagram for showing the internal structure of a speech processing module shown in FIG. 1;

FIG. 3 is a diagrammatic view for showing the structure of a method to change the voice by identifying the fundamental (pitch) frequency of the speaker and shift it left or right. In other words, creating bigger frequency pitch or smaller frequency pitch without destroying intelligibility, shown in FIG. 2; and

FIG. 4 is a flow chart for showing a caller's voice changing process according to a preferred embodiment of the invention.

### DETAILED DESCRIPTION OF THE PREFERRED EMBODIMENTS

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

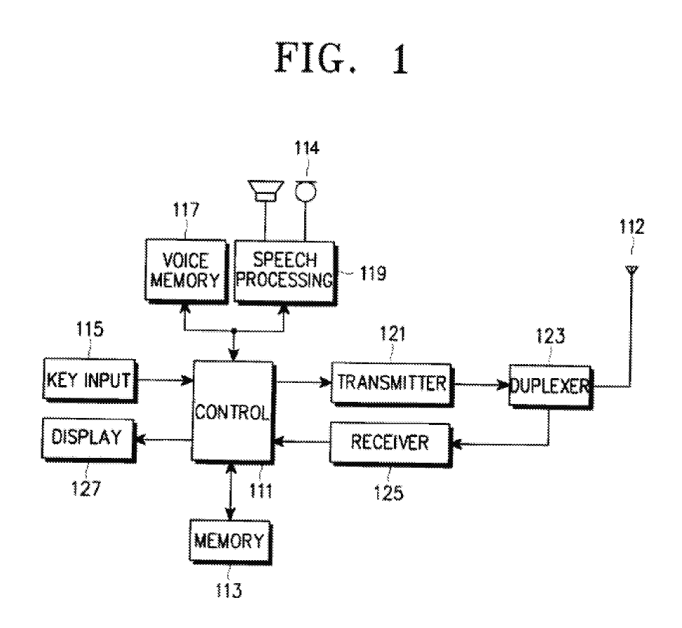

FIG. 1 is a block diagram showing the internal structure of a voice communication device for performing functions according to a preferred embodiment of the invention.

A control module 111 controls the overall operation of the voice communication device. A memory 113 stores control programs of the voice communication device and controls data generated under the control of the control module 111, and in particular varying the pitch coefficients which are set according to each of caller's voice such as an adult male voice, middle adult female voice, high child voice and combinations such as middle low, middle high, original caller voice etc.

A key input module 115 has a number of dialing digit keys, a menu key, a send key, etc. It generates key signals corresponding to the keys selected by the user to send the same to the control module 111.

A voice memory 117 stores a number of voice messages. When a voice message is read out from the voice memory 117 under the control of the control module 111, a speech processing module 119 processes the voice message into an analog signal and outputs the message via a speaker. Also, the speech processing module 119 processes analog voice of the user delivered via microphone 114 into digital signals. It also demodulates and outputs the received voice signals from a calling party or the called party to a telephone call.

A transmitter module 121 receives the signals generated from the control module 111 and modulates the same into digital signals to send them to a duplexer 123. The duplexer 123 transmits the radio signals received from the transmitter module 121 via an antenna 112. The duplexer 123 also sends signals received via the antenna 112 to a receiver module 125. The receiver module 125 demodulates the radio signals received from the duplexer 123, and sends the demodulated signals to the control module 111. The control module 111 controls conversation in response to the received signals.

A display module 127, which is realized by LCD (Liquid Crystal Display) or LED (Light Emitting Diode) etc., displays input data and control data of the voice communication device which is processed under the control of the control module 111.

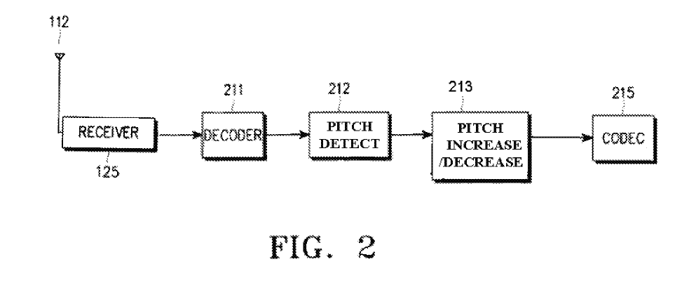

FIG. 2 is a block diagram showing the internal structure of a speech processing module shown in FIG. 1.

First, when a radio signal, such as a speech decoder signal, is received via the duplexer 123 from the counter part to the voice communication or cell phone call, the received signal is demodulated in the receiver module 125 and into a voice in the speech processing module 119 under the control of control module 111. The voice control module 119 is comprised of speech decoder 211, a pitch detection, or pitch determination module 212, pitch increase or decrease module 213 and a codec module 215.

The signal demodulated via the receiver module 125 is delivered to the speech decoder 211, which processes the compressed voice and decodes the demodulated signal. The speech decoder, 211 then outputs the decoded signal to the pitch determination module 212. The pitch determination or detection module 211 receives and calculates the pitch of the voice signal received from the voice decoder 211 to convert it to an uncompressed voice (some times called Pulse Coded Modulation signal or Differential Pulse Coded signal). Then the pitch increase/decrease module 213 shifts the pitch up or down. The uncompressed signal is delivered to the codec 215 thereby outputting an analog-modulated voice to a speaker or ear piece.

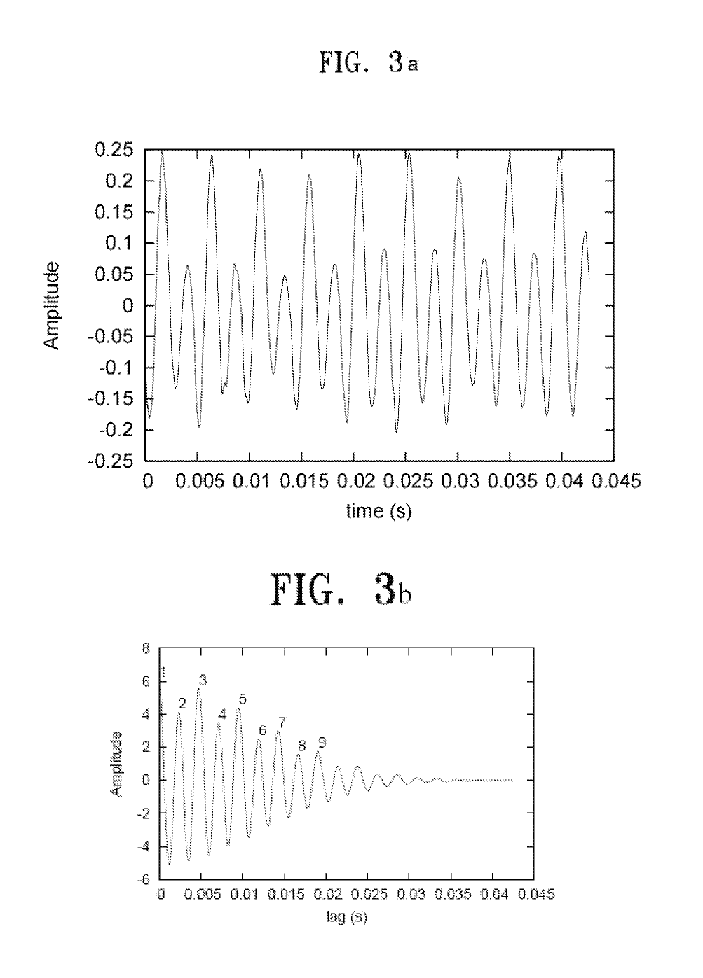

FIG. 3 shows a detailed description of the pitch detection performance described in FIG. 2.

The pitch detection module calculates the fundamental frequency in a signal x (n) by

$${φ}_{k} ( m ) = \frac{1}{N} {\sum }_{n = 0}^{N - 1} [ x ( n + k ) w ( n ) ] [ x ( n + k + m ) w ( n + m ) ] , \\ 0 \leq m \leq {M}_{C} - 1 , N \leq {M}_{C}$$

Where Mc is the number of points to be calculated,
N is the number of odd samples in the required segment,
K is the index of starting sample in the frame,
and W (n) is the time domain window function.

In a real time environment, like voice communication device, an efficient calculation could be expressed by two Discrete Time Fourier transforms:

$${φ}_{k} ( m ) = \frac{1}{N} {F}_{D}^{- 1} [ {F}_{D}^{*} [ x ( k ) ] {F}_{D} [ x ( k ) ] ] ,$$

Where F_{D} is a Discrete Time Fourier transform,
( )* is a complex conjugate function,
x(k) is the segment of the signal

The Discrete Time Fourier transform could efficiently be calculated by the Fast Fourier transform. The Fast Fourier Transform (FFT) is an efficient algorithm to compute the discrete Fourier Transform (DFT). FFTs are of great importance to a wide variety of applications, from digital signal processing to solvoing partial differential equations to algorithms for quickly multiplying large integers.

Let x₀, . . . , x_{N-1} be complex numbers. The DFT is defined by the formula

$${X}_{k} = {\sum }_{n = 0}^{N - 1} {x}_{n} {e}^{- \frac{2 πi}{N} nk}$$

$$k = 0 , … , N - 1.$$

Evaluating the above equation would normally take N² arithmetical operations. FFT is an algorithm to compute the same result in only NlogN operations.

FIG. 3a shows an input speech signal and 3b shows the lags to determine or compute the pitch. The original signal delivered to 312 always has its peak at lag value 0. In this case, it is value 1 on FIG. 3b. This is where the signal correlates with the original voice. The envelope of the autocorrelation graph for periodic signals follows the autocorrelation graphic sketch. In this case, it at peak number 3 in FIG. 3b and is caused by the periodic function at the fundamental frequency; which is the strongest periodicity in the signal.

There may be peaks between the zero lag value and the main-fundamental frequency peak as shown in FIG. 3b, which correspond to the harmonics of the fundamental frequency. The other peaks in the autocorrelations in FIG. 3b are caused by the main-fundamental frequency, and the higher harmonics delayed by the fundamental main frequency by more than a single cycle. Therefore, even peaks are caused by the main frequency and odd peaks are caused by the second harmonics. The main fundamental frequency is extracted by taking the lag value of highest peak in autocorrelation graph and applying the equation discussed above.

The signal thus generated is delivered to the memory module, 113. Here, a caller voice selector key is designated together with the pitch increase or decrease corresponding to different caller's voice. For example, the voice selector key is designated “1” when the pitch goes up according to a predetermined coefficient of the high voice, and the voice selector key is designated “2” when the filter coefficients are low (bass).

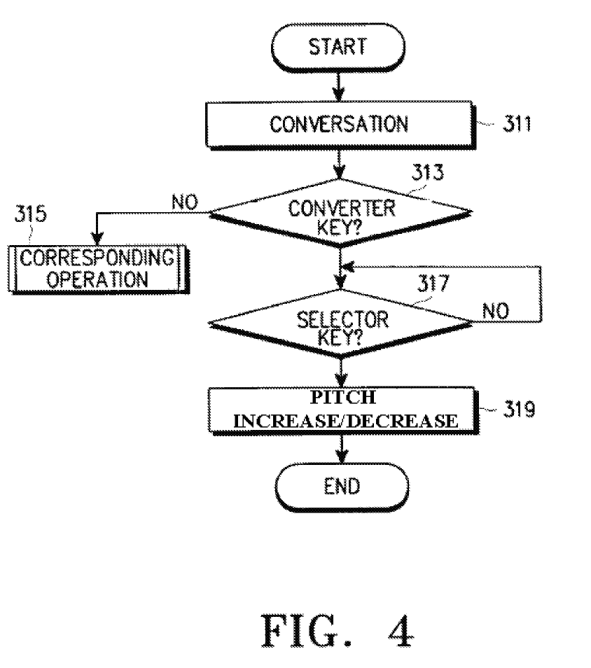

FIG. 4 is a flow chart for showing a caller voice changing process according to the preferred embodiment of the invention.

First, a telephone conversation is established at step 311. During the process of conversation, when a key signal from the key input module 115 is provided, the control module 111 proceeds to step 313. In step 313, the control module 111 determines if the key signal from the key input module 115 is a caller voice converter key signal. The caller voice converter key means a key which is set by the combination of a number of keys provided in the key input module 115. This is pressed to select a caller voice which is desired for conversion of the voices transmitted and received during conversation.

When it is determined that the key signal is not the caller voice converter signal, the control module 111 proceeds to step 315. In the step 315, the control module 111 performs an operation corresponding to the pressed key.

If it is determined that the key signal is the caller voice converter key signal, the control module proceeds to step 317. In step 317, the control module 111 determines if the caller voice selector key signal is applied from the key input module 115. Here, the caller voice selector key means a key which is set by combination of the number of keys provided in the key input module 115. This is pressed to select a caller voice, which is desired for voice conversion, such as low, middle, high, middle low, middle high and original caller voices corresponding to the input of the caller voice convert key. If the caller voice selector key signal is not provided during a previously set time period as a result of the inspection, the control module 111 processes the step as an error.

The control module 111 proceeds to step 319 if the caller voice selector key signal has been provided. In step 319, the control module 111 checks memory module 113 to detect the pitch corresponding to the provided caller voice selector key signal. The pitch is increased or decreased during the process of conversation.

Although not shown, upon detecting the end of the conversation after changing the pitch of the caller 213, the control module 111 changes the increase decrease of the pitch 213 back to the same coefficient as the original voice processing value.

As described hereinabove, the invention has the advantages of enabling a change and/or selection of the transmitted and/or received voices so that conversation can be presented to different users.

While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

What is claimed is:

1. A method for changing caller's voice in a voice communication device having a pitch detector and a pitch changer for changing the voice signal, the method comprises the steps of:
waiting for a caller voice selector key input for a desired caller voice when a caller voice converter key is pressed during conversation;
and setting a pitch detection to recognize a set of parameters corresponding to the caller voice selector key input and offsetting the pitch of the input signal to change voice.

2. The method for changing caller's voice in a voice communication device in accordance with claim 1, further comprising the step of changing the pitch parameters back to the original value when the conversation ends.

3. The method for changing caller's voice in a voice communication device in accordance with claim 2, wherein the parameters are found by autocorrelation pitch detection.

4. The method for changing caller's voice in a voice communication device in accordance with claim 3, wherein the pitch detector has finite autocorrelation coefficients structure.

5. A method for changing caller's voice in a voice communication device having a pitch detector for the uncompressed input speech signal, the method comprises the steps of:
autocorrelation matching of the pitch corresponding to each of the number of caller voices to change the uncompressed speech signal into the number of caller voices;
determining if a caller voice converter key is pressed during conversation when conversation starts; waiting for a caller voice selector key input for a desired caller voice when a caller voice converter key is pressed;
detecting a pitch set to the pressed caller voice selector key;
controlling the pitch of the uncompressed speech signal with the detected pitch;
and offsetting the pitch of signal streamed out to audio.

6. The method for changing caller voice of a voice communication device in accordance with claim 5, further comprising the step of increasing or decreasing the pitch of the original caller voice when the conversation ends.

7. The method for changing caller voice of a voice communication device in accordance with claim 5, wherein the pitch detector is an autocorrelation detector.
